(19) United States
(12) Patent Application Publication
(10) Pub. No.: US 2013/0294722 A1
(43) Pub. Date: Nov. 7, 2013

(54) Practical multiply resonant photonic crystal nanocavity

(71) Applicant: The Board of Trustees of the Leland Stanford Junior University, (US)

(72) Inventors: Jelena Vuckovic, Palo Alto, CA (US); Kelley Rivoire, Palo Alto, CA (US); Sonia M. Buckley, Los Altos Hills, CA (US); Jesse Lu, East Palo Alto, CA (US)

(21) Appl. No.: 13/857,413

(22) Filed: Apr. 5, 2013

Related U.S. Application Data
(60) Provisional application No. 61/620,909, filed on Apr. 5, 2012.

(51) Int. Cl. G02F 1/35; G02F 1/365

(52) U.S. Cl. CPC G02F 1/3534; G02F 1/365
USPC 385/14; 385/122

(57) ABSTRACT

Intersecting photonic crystal structures provide overlapping cavity modes that can have widely separated resonant frequencies. These photonic crystal structures can be either 1-D photonic crystal structures or 2-D photonic crystal structures. If a material having the zincblende crystal structure is employed (e.g., GaAs), it is preferred for the crystal orientation to be (110) or (111), because these orientations can provide three wave mixing for three TE-like modes.

### CROSS REFERENCE TO RELATED APPLICATIONS

This application claims the benefit of U.S. provisional patent application 61/620,909, filed on Apr. 5, 2012, entitled “A practical multiply resonant photonic crystal nanocavity”, and hereby incorporated by reference in its entirety.

### GOVERNMENT SPONSORSHIP

This invention was made with Government support under contract number ECCS-10 25811 awarded by the National Science Foundation. The Government has certain rights in this invention.

### FIELD OF THE INVENTION

This invention relates to photonic crystal structures, especially in connection with nonlinear optical devices.

### BACKGROUND

One approach for increasing the efficiency of nonlinear electromagnetic interactions is to confine one or more of the interacting modes in a resonant cavity. Such resonant cavities can be provided in various ways. For example, photonic crystal structures can be used to define resonant cavities. A photonic crystal structure includes periodic features (e.g., holes) having a period comparable to the relevant electromagnetic wavelength.

In cases where modes of significantly different frequency interact, resonant cavities can be defined with photonic crystal structures that correspond to the interacting wavelengths. For example, in US 2012/0194901 difference frequency generation of THz radiation from optical radiation using triply-resonant photonic crystal resonators is considered.

### SUMMARY

However, we have found that certain aspects of nonlinear optical interactions using photonic crystal resonators are both unexpected and do not appear to have been appreciated in the art.

The first aspect is the significance of crystal orientation. In particular, it turns out that (110) or (111) crystal orientation is often much better than the more commonly used (100) crystal orientation, especially for frequency conversion in photonic crystal cavities in materials with a zincblende crystal structure.

The second aspect is the discovery that 2-D photonic crystal structures can be used to define interacting cavity modes having significantly different frequencies.

In general, the present work provides techniques for creating multiply resonant, spatially overlapping photonic crystal cavities with individually tunable resonant frequencies. These approaches are generally applicable. Applications include:

1) Second order (χ⁽²⁾) nonlinear optical frequency conversion (e.g. second harmonic generation, sum frequency generation, difference frequency generation) in crystalline materials (e.g., III-V semiconductors with crystal orientation of (110) or (111)).
2) Third order (χ⁽³⁾) nonlinear optical frequency conversion (e.g. Raman, four wave mixing) in any material.

3) Degenerate frequency, orthogonally polarized cavities for applications such as polarization-independent sources, polarization entangled photon sources based on cascaded emission from a single quantum emitter, and coupling to spin states of embedded quantum emitters.

Such multiply resonant cavities can provide numerous advantages:

1) Creation of multiple first order photonic band gaps at far separated frequencies in a thin slab—Existing methods for localizing light with multiple band gaps tend to require higher order band gaps that decrease in size for thin slabs and which are lossy due to their position above the light line.

2) Ability to widely and separately tune frequencies of each resonance for a fixed slab size—Existing methods using multiple modes from a single photonic band gap tend to have minimal tunability. Existing methods using TE and TM band gaps of nanobeams require tuning slab thickness to tune resonant frequency separation.

3) Ability to use TE modes only, which can be strongly localized in thin slabs—Existing methods requiring TM modes necessitate the use of thick semiconductor membranes.

4) Ability to fabricate in thin semiconductor slabs—Existing methods involving lattices with reduced symmetry, multiple band gaps, or TM modes all require thicker semiconductor slabs which can be more difficult to etch.

5) Ability to maintain strong spatial overlap between multiple resonances—Existing methods involving multiple modes of a single photonic band gap cavity typically have low spatial overlap, due to mode orthogonality.

6) Ability to tune resonant frequencies to account for fabrication inaccuracies in a relatively straightforward way—Existing methods often affect all resonances in a complicated way, while the present approach tends to provide devices having relatively decoupled tuning, where varying a single device parameter primarily affects only one of the resonances. This can be especially useful for fine-tuning degenerate or nearly degenerate frequency resonances.

7) Ability to spatially select different resonances because they are coupled from different directions on the device—Existing methods often have all resonances in/out coupled from the same direction.

### BRIEF DESCRIPTION OF THE DRAWINGS

FIG. 1A shows a side view of a first embodiment of the invention.

FIG. 1B shows a top view corresponding to the side view of FIG. 1A.

FIG. 1C shows an alternative to the side view of FIG. 1A.

FIG. 2 shows a top view of a second embodiment of the invention.

FIGS. 3A-B show an example of two 2-D photonic crystal structures supporting overlapping cavity modes.

FIGS. 4A-B show another example of two 2-D photonic crystal structures supporting overlapping cavity modes.

FIG. 5A is an image of an experimental device having intersecting orthogonal nanobeams.

FIG. 5B is a thresholded binary image of the image of FIG. 5A.

FIG. 5C shows a finite-difference time-domain (FDTD) simulation of the horizontal cavity mode in the structure of FIG. 5A.

FIG. 5D shows measured horizontal-mode reflectivity in the structure of FIG. 5A.

FIG. 5E shows an FDTD simulation of the vertical cavity mode in the structure of FIG. 5A.

FIG. 5F shows measured vertical-mode reflectivity in the structure of FIG. 5A.

FIG. 6A is an image of a second experimental device having intersecting orthogonal nanobeams.

FIG. 6B shows an FDTD simulation of the horizontal cavity mode in the structure of FIG. 6A.

FIG. 6C shows an FDTD simulation of the vertical cavity mode in the structure of FIG. 6A.

### DETAILED DESCRIPTION

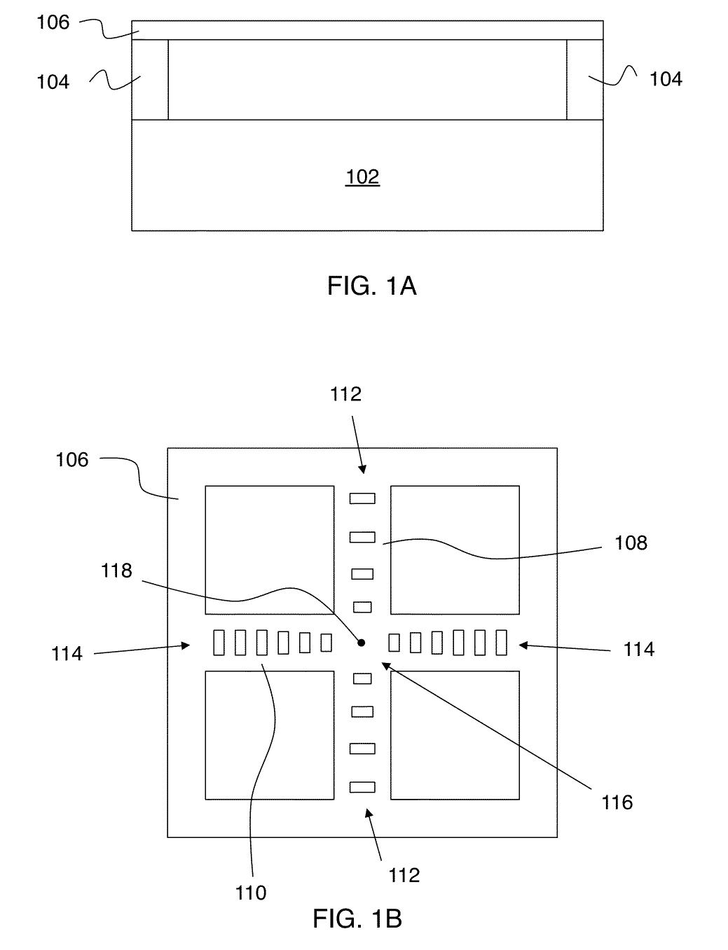

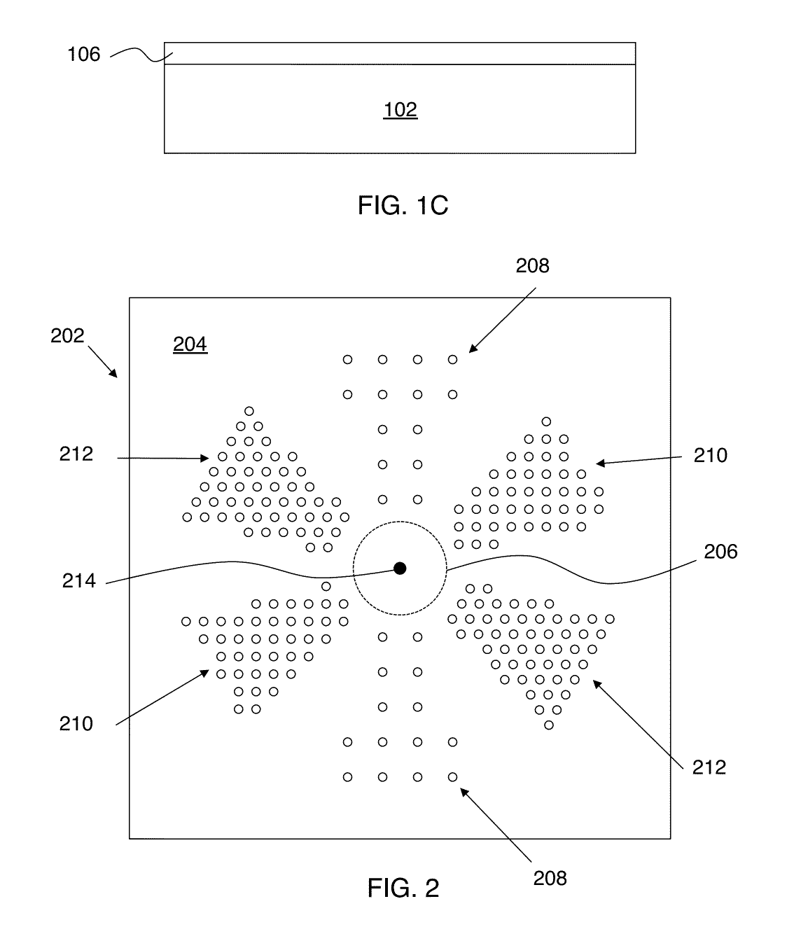

FIG. 1A shows a side view of a first embodiment of the invention. FIG. 1B shows a top view corresponding to the side view of FIG. 1A. In this example, a slab 106 is suspended above a substrate 102 by support members 104. Slab 106 has waveguides 108 and 110 formed in it. Waveguides 108 and 110 intersect at intersection region 116. Waveguide 108 includes resonance features 112 such that a resonant mode is formed in waveguide 108 that is localized to intersection region 116. Similarly, waveguide 110 includes resonance features 114 such that a resonant mode is formed in waveguide 110 that is localized to intersection region 116. Thus, intersection region 116 acts as a resonant cavity with resonances defined by the resonance features 112 and 114 of waveguides 108 and 110. This structure can be described as two orthogonally crossed nanobeam photonic crystal cavities, where the cavity fields overlap in nonlinear material at the intersection of the two beams. This structure can be fabricated in a very thin, high index semiconductor membrane. Preferably, the membrane thickness is on the order of λ/2, where λ is the wavelength of the resonant light in the material.

For structures of this kind, we have found that crystal orientation is a significant parameter. Specifically, the waveguides should have either (110) or (111) crystal orientation. In practice, this can be achieved by using a substrate 102 having a (110) or (111) crystal orientation for its top surface, and ensuring that the waveguides have the same crystal orientation as the substrate. Suitable methods for fabricating such structures are known in the art (e.g., processing techniques for compound semiconductors). To better appreciate the significance of the crystal orientation, some design considerations relating to nonlinear conversion in zincblende semiconductors follow.

In order to increase the efficiency of a triply-resonant three wave mixing process, we consider:

1) maximizing overlap of the three modes involved,
2) maximizing quality factors of the three modes, and
3) maximizing mode volume of the three modes.
Optimization of the efficiency may involve a trade-off between 1), 2) and 3). Additionally, the symmetry of the χ⁽²⁾ tensor of the material being used must be taken into account, as well as the symmetry of the photonic crystal mode.

In a suspended photonic crystal structure which is symmetric about a plane through the center of the membrane (e.g., as shown on FIG. 1A), modes are either TE-like or TM-like in polarization, by symmetry. For a TE-like mode at the center of the photonic crystal slab, the electric field along the axis normal to the plane of the wafer (E_{z}), and the magnetic fields in the plane in the wafer (Hₓ, H_{y}) are zero (more precisely, these field components are negligibly small for finite thickness, and are zero in the corresponding modes for infinite thickness), while the electric fields in the plane of the wafer (Eₓ and E_{y}) are non-zero, as is the magnetic field normal to the plane of the wafer (H_{z}). For a TM-like mode at the center of the photonic crystal slab, Eₓ, E_{y} and H_{z} are zero/negligible, while Hₓ, H_{y}, and E_{z} are non-zero. For simplicity, TE and TE-like will be regarded as synonyms in the following description. These symmetries must be taken into account when calculating allowed nonlinear interactions in photonic crystal cavities.

For GaAs, the χ⁽²⁾ tensor is defined such that x, y, z are the [100], [010] and [001] axes of the crystal structure. The only non-zero components of this tensor are χ⁽²⁾_{xyz}=χ⁽²⁾_{yzx}=χ⁽²⁾_{zxy}.

For the case of (100) GaAs, the x and y axes are in the same plane as two of the crystal axes, and can be therefore be chosen to be aligned with the crystal axes. In other words, the xyz coordinates used to define TE and TM above, and the xyz coordinates for the χ⁽²⁾ tensor are the same coordinate systems for (100) GaAs. As indicated above, TE-like modes have x and y components of the electric field, but no/negligible z component of the electric field. Thus, a three wave mixing process involving three TE-like modes cannot occur in a photonic crystal cavity structure in 100 oriented III-V semiconductors. The reason for this is that there are no non-zero χ⁽²⁾ tensor components all in the x-y plane such as xyx, xyy, etc. that could support such an interaction. In effect, this means that all χ⁽²⁾ three wave mixing processes in (100) GaAs must involve both a TE mode and a TM mode, which can complicate design. For example, in order to engineer the modes to increase the efficiency of the nonlinear interaction, both a TE mode and a TM mode would need to be optimized in (100) GaAs (or other (100) III-V semiconductors).

In the case of (111) or (110) oriented GaAs, the plane of the wafer is no longer the same as the plane of crystal axes. Here we have two different coordinate systems, so we let x′, y′, z′ refer to the wafer coordinates (TE and TM are defined in terms of the x′, y′, z′ coordinates), and we let x, y, z refer to the χ⁽²⁾ tensor coordinates. For example, in (111) or (110) GaAs this means that x′ and y′ in the plane of the wafer now have components along all of x, y and z of the crystal axes, and so while a TE mode still has the normal electric field E_{z}′=0, in the crystal axes coordinate system Eₓ, E_{y} and E_{z} are all non-zero, and thus TE-TE-TE mode conversion is allowed. We can calculate the efficiency in this case by either transforming the electric field components to the crystal coordinate system (i.e., relate Eₓ′,E_{y}′,E_{z}′ to Eₓ,E_{y},E_{z}) or deriving an effective χ⁽²⁾ tensor specific to the crystal orientation being considered. Using this wafer orientation, it is now possible to engineer three TE modes to have a good overlap and quality factor in order to optimize the efficiency of the three wave mixing process. The crossbeam photonic crystal cavities of the examples given below have been optimized to have two TE modes with good overlap and quality factor.

To summarize, 1) TE-TE-TE interactions are preferred for simplicity of design, 2) TE-TE-TE interactions are impossible in zincblende semiconductors having (100) orientation, 3) TE-TE-TE interactions are possible in zincblende semiconductors having (110) or (111) orientations, therefore 4) it is preferred for the substrate orientation to be (110) or (111), which leads to the cavity/waveguide material having the desired (110) or (111) crystal orientation (same as the substrate).

The resonance features of this example preferably include 1-D photonic crystal structures (e.g., an periodic array of holes in the waveguide). Such features can be tailored to optimize device performance (e.g., the hole size can be tapered down as the cavity is approached, as shown in the example of FIG. 1B).

The semiconductor waveguides can have a second order optical nonlinearity such that three wave mixing occurs between a first resonant mode in a first waveguide, a second resonant mode in a second waveguide, and a third resonant mode in either the first or second waveguides. In this case, it is preferred that the first resonant mode, the second resonant mode and the third resonant mode be all transverse electric-like modes with respect to their corresponding waveguides. Here a mode is defined as TE-like if the corresponding mode in an infinite thickness structure is transverse electric. In practice, a TE-like waveguide mode has mainly transverse electric field components, but also has a relatively small longitudinal electric field component.

Such three wave mixing can be any second order nonlinear optical process, including but not limited to: second harmonic generation, sum frequency generation, difference frequency generation, optical parametric amplification, and optical parametric oscillation.

Preferably, the semiconductor waveguides have a zincblende crystal structure. More specifically, the considerations given above are applicable to crystal structures having 4̅3m and 4̅2m symmetry. Materials having such symmetry include GaAs, GaP, InGaP, InP, and zincblende forms of SiC. Substrate orientation may also be significant for wurtzite crystal structures (e.g., GaN and some forms of SiC). The substrate orientations that permit TE-TE-TE three wave mixing in wurtzite structures can be determined according to the above-described principles.

Preferably, the semiconductor waveguides include two or more waveguides intersecting at substantially equal angles. The example of FIG. 1B shows two waveguides intersecting at 90° angles. We could also have three waveguides intersecting at 60° angles, four waveguides intersecting at 45° angles, etc.

Optionally, an optical emitter 118 can be embedded in intersection region 116. Any kind of emitter can be employed, although it is preferred for the emitter (if present) to be a localized source (e.g., a quantum dot). Suitable emitters include, but are not limited to: quantum wells, quantum dots, nitrogen vacancy centers, and thin films of molecules. Such structures can provide frequency conversion of photons emitted by these emitters, including frequency conversion of single photons.

In most cases, it is preferred for the waveguides to be formed in a slab that is suspended over the substrate (e.g., as shown on FIGS. 1A-B). Alternatively, the slab can be disposed on the substrate, as shown in the side view of FIG. 1C. If the slab is disposed on the substrate, it will be important to ensure that the proximity of the resonant cavity in the intersection region to the substrate does not overly degrade the quality factor of the relevant resonances.

The preceding example can be regarded as the use of 1-D photonic crystals to individually define interacting cavity modes in a resonant cavity. We have found, surprisingly, that this same general idea can be extended to 2-D photonic crystal structures. FIG. 2 is a schematic illustration of the basic ideas. In this example, a photonic crystal device 202 includes a first 2-D photonic crystal structure 208, a second 2-D photonic crystal structure 210, and a third 2-D photonic crystal structure 212. Each of these photonic crystal structures is configured as two ends sandwiching a common cavity region 206. The cavity region 206 and all of the photonic crystal structures are formed by patterning a single slab 204 of material (i.e., FIG. 2B is a top view of slab 204, side views would be as in FIG. 1A or 1C).

The periodicities of these photonic crystal structures differ, in period and/or in lattice type. For example, photonic crystal structures 208 and 210 both have square lattices, but have significantly different periods, while photonic crystal structure 212 has a triangular lattice with a period comparable to that of photonic crystal structure 210. For ease of illustration, unpatterned material is shown separating the different photonic crystal structures on FIG. 2. In practice, as will be seen in the following examples, it is preferred for the photonic crystal structures to somewhat overlap with each other. 2-D photonic crystals that overlap with each other can be distinguished by their differing periodicities, with a small amount of ambiguity in regions of overlap. Optionally, an optical emitter 214 can be present in the cavity region. As above, a localized emitter (e.g., a quantum dot) is preferred. Suitable emitters include, but are not limited to: quantum wells, quantum dots, nitrogen vacancy centers, and thin films of molecules. Such structures can provide frequency conversion of photons emitted by these emitters, including frequency conversion of single photons.

Structures of this kind can be used to provide resonances at significantly different frequencies. Let two 2-D photonic crystal structures in the slab have periods P1 and P2. Significant period differences (e.g., P1/P2>1.3) can be provided. The resulting resonant frequencies will have a ratio comparable to the ratio of photonic crystal periods.

The example of FIG. 2 shows three intersecting 2-D photonic crystal structures. In general, two or more intersecting 2-D photonic crystal structures can be employed.

For the important practical case of zincblende semiconductors, the considerations given above relating to crystal orientation are also relevant for these intersecting 2-D photonic crystal structures. Thus, if the slab of material 204 has a zincblende crystal structure, it is preferred for it to have a 110 or 111 crystal orientation for its top surface.

This idea of intersecting 2-D photonic crystal structures is applicable to any field where such control of cavity modes may be useful. In particular, it is applicable for nonlinear optical interactions of any order, such as second order and third order nonlinear optical processes.

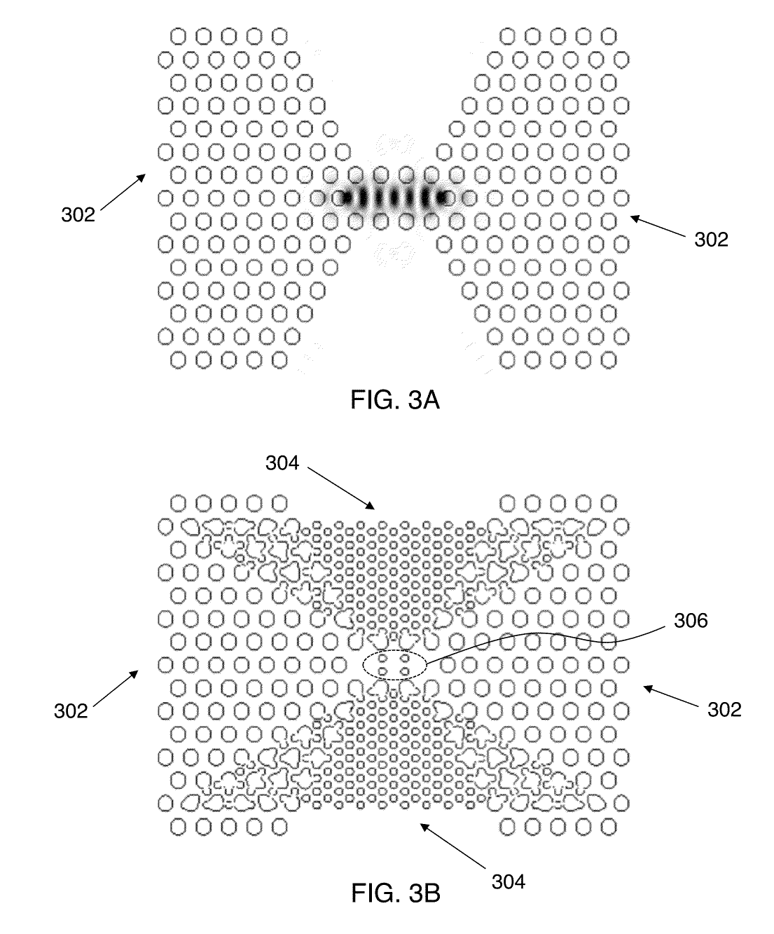

FIGS. 3A-B show an example of two 2-D photonic crystal structures supporting overlapping cavity modes. FIG. 3A shows a simulation of a cavity mode in a cavity defined by a photonic crystal structure 302. From the simulation, it can be seen that this mode mainly propagates back and forth horizontally on the figure (as opposed to vertically). Thus, photonic crystal features vertically above and below the mode can be removed (as shown on FIG. 3A) with a comparatively small effect on the mode quality factor.

More significantly, this empty vertical space can be filled in with a different photonic crystal structure 304, as shown on FIG. 3B. Photonic crystal structure 304 serves to provide confinement to a second mode (not shown) that mainly propagates up and down on the figure. Thus, two independent cavity modes can be confined to the same cavity region 306.

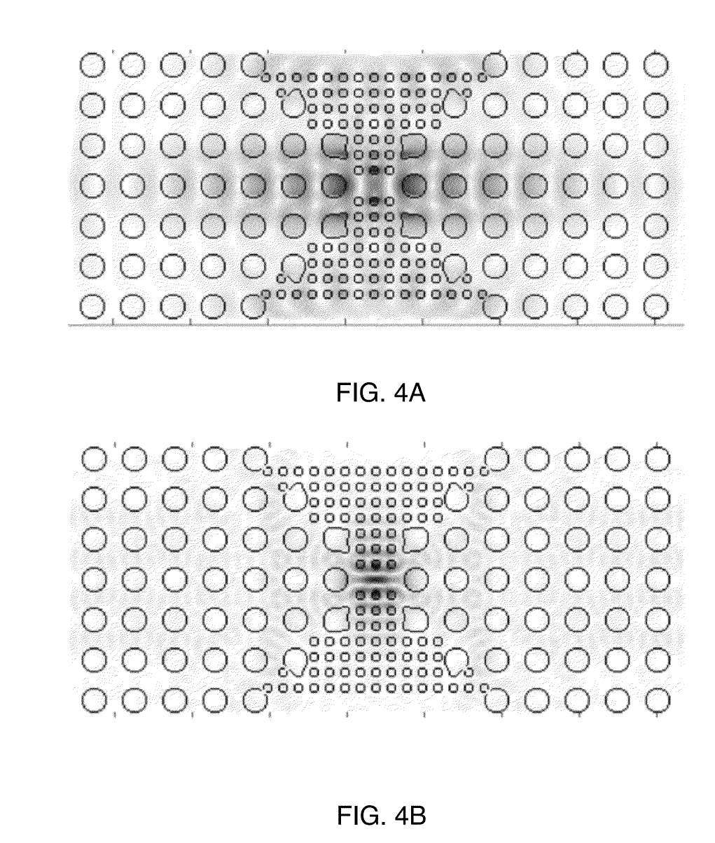

FIGS. 4A-B show another example of two 2-D photonic crystal structures supporting overlapping cavity modes. In this example, FIG. 4A shows a simulation of the horizontally confined mode, and FIG. 4B shows a simulation of the vertically confined mode. These modes are simulated for material parameters of GaP and wavelengths of 1500 nm (FIG. 4A) and 750 nm (FIG. 4B). The large lattice constant is 500 nm, while the small lattice constant is 192 nm. Each mode here has a simulated quality factor of about 100. A simple square lattice for the 1500 nm mode and these material parameters (i.e., FIG. 4A with the small holes removed and filled in with the large holes in the proper pattern) has a simulated quality factor of about 300. Thus, by taking advantage of the symmetries of specific cavity modes, it is possible to substantially maintain the quality factors of the original modes while overlapping two modes of very different frequencies in a small region of nonlinear material.

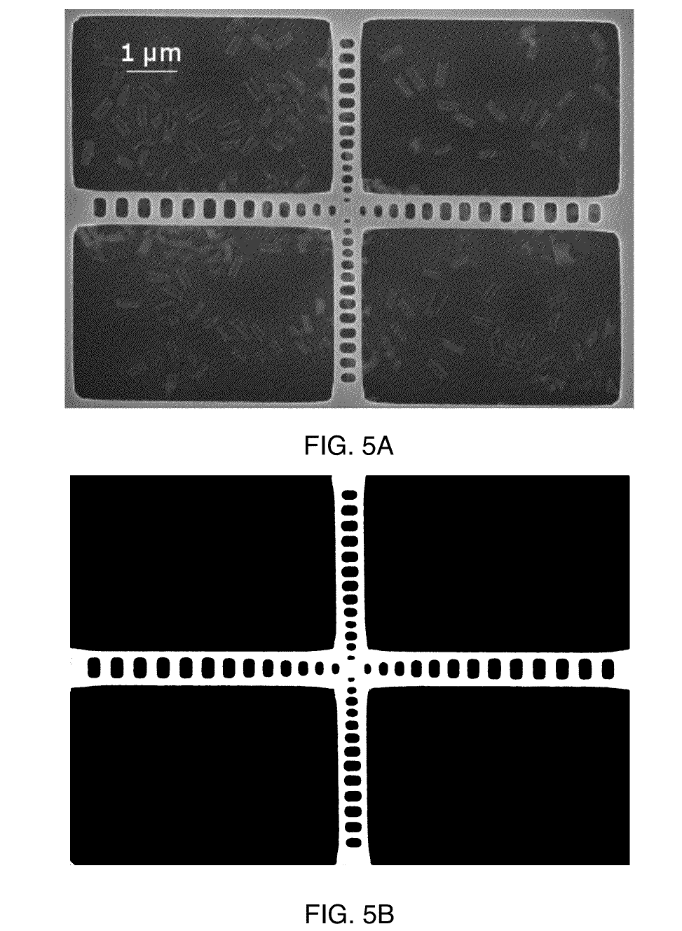

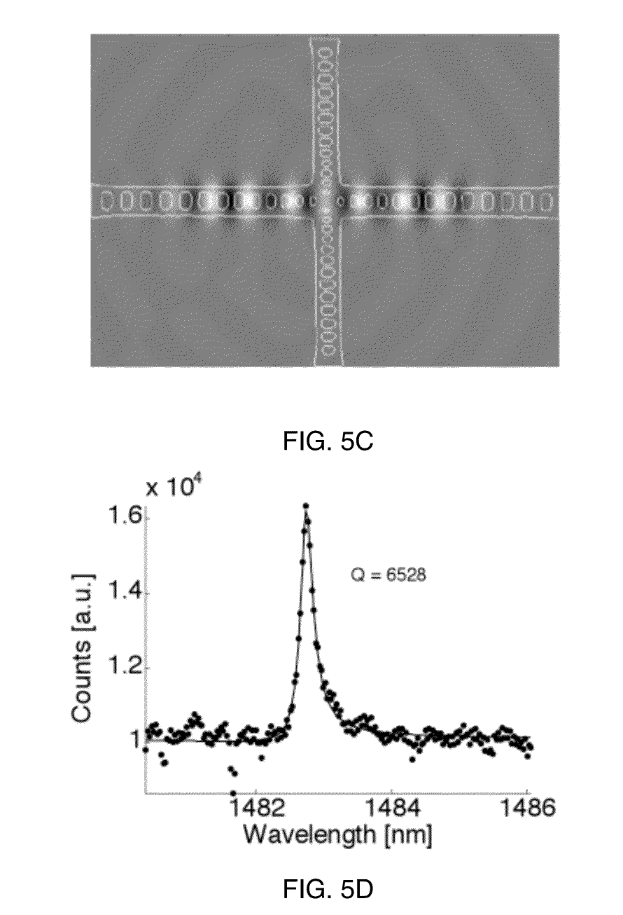

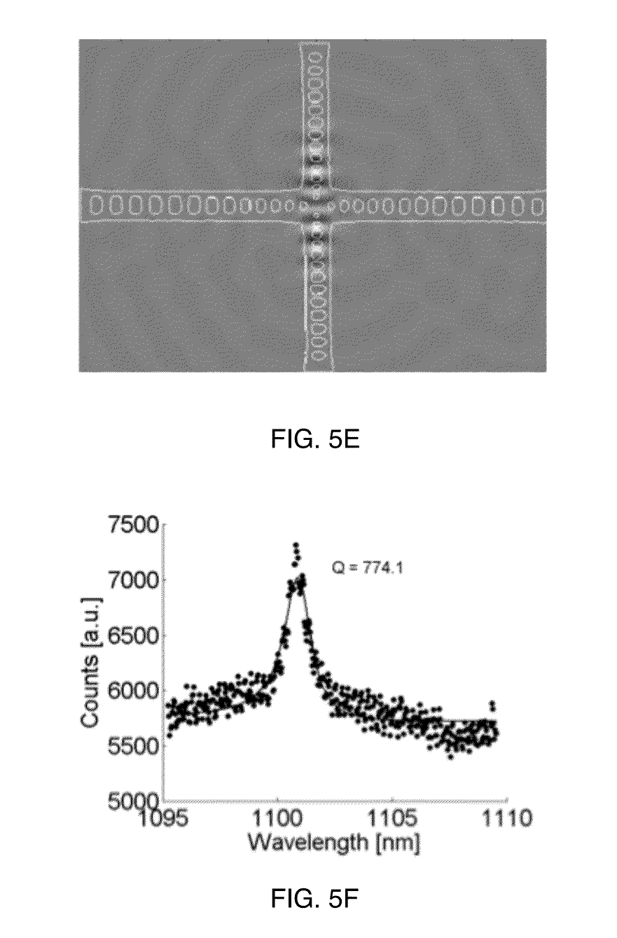

FIGS. 5A-F relate to proof of concept experimental work for intersecting nanobeam structures in GaAs having a (100) crystal orientation. Although the crystal orientation in this work is not suitable for TE-TE-TE three-wave mixing, the fabricated structures do serve to prove the concept of multiple resonances at well-separated frequencies in a crossed nanobeam structure.

FIG. 5A is an image of a experimental device having intersecting orthogonal nanobeams. These nanobeams are formed in a slab of GaAs that is 164 nm thick, and which is suspended above the substrate by wet etching a sacrificial AlGaAs layer between the nanobeam slab and the substrate. The nanobeam pattern is defined by e-beam lithography and dry etching. FIG. 5B is a thresholded binary image of the image of FIG. 5A. This thresholded image is used to provide structure geometry input for simulations relating to the fabricated structure.

FIG. 5C shows a finite-difference time-domain (FDTD) simulation of the horizontal cavity mode in the structure of FIG. 5A. FIG. 5D shows measured horizontal-mode reflectivity in the structure of FIG. 5A. A high-Q resonance is present at about 1482.7 nm.

FIG. 5E shows an FDTD simulation of the vertical cavity mode in the structure of FIG. 5A. FIG. 5F shows measured vertical-mode reflectivity in the structure of FIG. 5A. A high-Q resonance is present at about 1101 nm. This structure demonstrates two resonant modes that overlap at the intersection of the nanobeams and which have well-separated frequencies, in accordance with the principles described above.

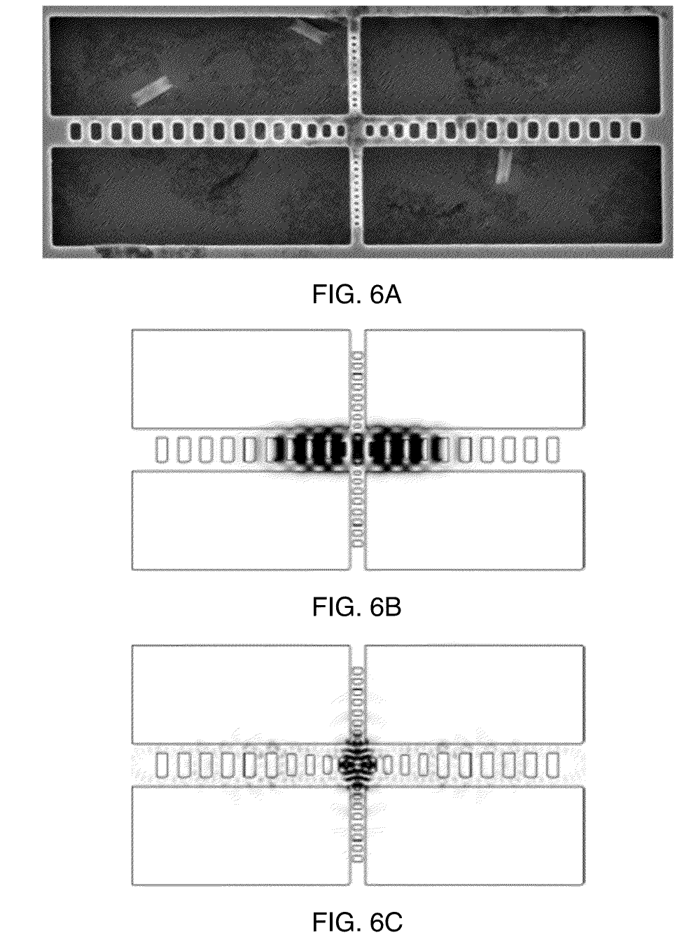

Experiments are in progress relating to (111) crystal orientation. FIG. 6A is an image of a second experimental device having intersecting orthogonal nanobeams. This structure was fabricated in GaAs having a (111) crystal orientation, and is intended to have resonances at frequencies of 1.3 μm and 2.6 μm, which differ by a factor of two. Such a structure can be simultaneously resonant for both the pump and the second harmonic in second harmonic generation.

FIG. 6B shows an FDTD simulation of the horizontal cavity mode (i.e., the pump mode) in the structure of FIG. 6A. FIG. 6C shows an FDTD simulation of the vertical cavity mode (i.e., the second harmonic mode) in the structure of FIG. 6A.

The preceding examples relate to a single resonant cavity. However, multiple cavities can also be implemented in this manner. For example, a network of intersecting waveguides could have a cavity at each intersection location. Such a network can be integrated onto a single optical chip.

Practice of the invention does not depend critically on the materials employed. Any material in which such photonic crystal structures can be fabricated can be employed. Suitable materials include, but are not limited to gallium arsenide, gallium phosphide, silicon, germanium, silicon nitride, silicon carbide, indium phosphide, silicon dioxide, and gallium nitride. For nonlinear optical applications, the material needs to have a suitable nonlinear optical response.

1. A nonlinear optical device comprising:
a crystalline substrate having (110) or (111) crystal orientation for its top surface;
two or more crystalline waveguides disposed on or above the substrate in the same plane, each of the waveguides having a crystal orientation that is the same as the substrate crystal orientation;
wherein the two or more waveguides intersect at an intersection region;
wherein each of the two or more waveguides includes resonance features such that a resonant mode is formed in the waveguide and localized to the intersection region.

2. The device of claim 1, wherein the resonance features comprise 1-D photonic crystal structures.

3. The device of claim 1, wherein the semiconductor waveguides have a second order optical nonlinearity such that three wave mixing occurs between a first resonant mode in a first waveguide, a second resonant mode in a second waveguide, and a third resonant mode in either the first or second waveguides.

4. The device of claim 3, wherein the first resonant mode, the second resonant mode and the third resonant mode are all transverse electric-like modes with respect to their corresponding waveguides.

5. The device of claim 3, wherein the three wave mixing is selected from the group consisting of: second harmonic generation, sum frequency generation, difference frequency generation, optical parametric amplification, and optical parametric oscillation.

6. The device of claim 1, wherein the semiconductor waveguides have a zincblende crystal structure.

7. The device of claim 1, wherein the semiconductor waveguides comprise two or more waveguides intersecting at substantially equal angles.

8. The device of claim 1, further comprising an optical emitter embedded in the intersection region.

9. The device of claim 1, wherein the semiconductor waveguides are formed in a slab that is suspended over the substrate.

10. The device of claim 1, wherein the semiconductor waveguides are formed in a slab that is disposed on the substrate.

11. A photonic crystal structure comprising:
a cavity region;
a first 2-D photonic crystal structure having a first periodicity and supporting a first cavity mode in the cavity region;
a second 2-D photonic crystal structure having a second periodicity distinct from the first periodicity and supporting a second cavity mode in the cavity region;
wherein the cavity region and the first and second 2-D photonic crystal structures are formed by patterning a single slab of material; and
wherein the first and second 2-D photonic crystal structures are each configured as two ends sandwiching the cavity region.

12. The photonic crystal structure of claim 11, wherein a period of the first periodicity is greater than a period of the second periodicity, and wherein a ratio of the first period to the second period is greater than 1.3.

13. The photonic crystal structure of claim 11, further comprising one or more additional 2-D photonic crystal structures in the slab of material and configured as two ends sandwiching the cavity region.

14. The photonic crystal structure of claim 11, wherein the slab of material has a zincblende crystal structure and has a (110) or (111) crystal orientation for its top surface.

15. The photonic crystal structure of claim 11, further comprising an optical emitter embedded in the cavity region.

16. A nonlinear optical device including the photonic crystal structure of claim 11, wherein the slab of material has a second order optical nonlinearity and/or a third order optical nonlinearity.
